(19) United States
(12) Patent Application Publication
(10) Pub. No.: US 2025/0363890 A1
(43) Pub. Date: Nov. 27, 2025

(54) METHOD FOR IDENTIFYING A VEHICLE IN A TRAFFIC AREA

(71) Applicant: Continental Automotive Technologies GmbH, Hannover (DE)

(72) Inventors: Alexander Sauermann, Alzenau (DE); Michael Goldhammer, Haibach (DE); Andreas Fuchs, Niedernberg (DE); Peter Quittenbaum, Bad Vilbel (DE); Marc Schneider-Enterlein, Nidda (DE)

(73) Assignee: Continental Automotive Technologies GmbH, Hannover (DE)

(21) Appl. No.: 19/218,248

(22) Filed: May 24, 2025

(30) Foreign Application Priority Data
May 24, 2024 (DE) 10 2024 204 826.7

(51) Int. Cl. G08G 1/017; G08G 1/04; G08G 1/052; G08G 1/056

(52) U.S. Cl. CPC G08G 1/017; G08G 1/04; G08G 1/052; G08G 1/056

(57) ABSTRACT

A method for identifying a vehicle in a traffic area with a traffic monitoring system is disclosed. The traffic monitoring system has a transmitter for a signal, a receiver for receiving the signal reflected by an object, and a control unit. A reflector is arranged on a vehicle moving in the traffic area and can be pivoted about at least one axis. The method comprises moving the reflector about the at least one axis with a movement pattern that is associated with the vehicle and generates a defined signal characteristic of the signal reflected by the reflector, capturing the signal reflected by the reflector with the receiver, identifying the vehicle if the signal characteristic of the signal reflected by the reflector that is received by the receiver corresponds to a signal characteristic that is associated with the movement pattern and is stored in the traffic monitoring system.

### TECHNICAL FIELD

The invention relates to a method for identifying a vehicle in a traffic area.

### BACKGROUND

The degree of automation of traffic is becoming more and more, because it is intended to improve both safety in traffic and comfort for the driver and the occupants of a vehicle. This is the reason why systems are being developed that take care of parking and automated driving for the driver or the vehicle occupants. In this case, the vehicle is transferred to the system at a transfer station and is controlled by the system to a target position by the transmission of control commands. The system also includes cameras that generate data relating to the vehicle and send them to the system. The system uses these transmitted data to control the vehicle to a target position. However, the cameras have the challenge that, when installed outside a covered parking region, for example on an outdoor parking area adjacent to the parking garage, they generate data unsuitable for control, since they are adversely affected by environmental influences, such as rain or sunlight.

### SUMMARY

An object of proposing a method for identifying a vehicle in a traffic area, which makes it possible to uniquely identify the vehicle irrespective of environmental influences.

To achieve the object, a method for identifying a vehicle in a traffic area with a traffic monitoring system is provided. The traffic monitoring system has a transmitter for a signal, a receiver for receiving the signal reflected by an object, and a control unit. A reflector for the signal is arranged on a vehicle moving in the traffic area. The reflector can be pivoted about at least one axis. The reflection properties for the signal depend on the direction. The method has the following steps: moving the reflector about the at least one axis with a movement pattern that is associated with the vehicle and generates a defined signal characteristic of the signal reflected by the reflector, capturing the signal reflected by the reflector with the receiver, and identifying the vehicle if the signal characteristic of the signal reflected by the reflector that is received by the receiver corresponds to a signal characteristic that is associated with the movement pattern and is stored in the traffic monitoring system.

A traffic area may mean the area in which road users, such as vehicles and/or pedestrians and/or cyclists, move. The traffic area can be in a building, such as a parking garage, or outdoors, such as a parking area or a road intersection.

A traffic monitoring system is a system that registers, identifies and takes control of a vehicle in the traffic area and transmits data, such as the target position and/or blocked regions, to the vehicle. The traffic monitoring system comprises the transmitter, the receiver and the control unit. This allows the traffic monitoring system to uniquely identify a vehicle in the traffic area and to transmit the correct control commands or data to the vehicle. The term control is synonymous with regulation.

A transmitter may mean a device or unit that can generate a signal and transmit it in a defined direction. The signal may be radiation-based or particle-based, for example radar beams, laser beams or light beams. A transmitter based on radiation or particles can be, for example, a radar, a lidar or an ultrasonic sensor. However, transmitters based on acoustics are also conceivable, such as ultrasonic waves.

A receiver may mean detectors which detect a signal consisting of radiation or particles. For example, a signal can be radar beams, laser beams, light beams or ultrasonic waves.

A control unit is any type of computer-aided computing unit that can perform calculations and/or generate control commands. The calculations can be used, for example, to determine speeds, distances or deviations. The control commands can be specific control commands, wherein actuators in the automobile, such as steering systems, the brake or engine, are controlled. However, control commands may also be understood as meaning waypoints which can be headed for independently by the automobile by means of the sensors inside the vehicle. A computer or microcontroller can be used as the control unit. Alternatively, server-based computers can be used as the control unit.

A reflector may be understood as any means that can reflect the signal. The signal may be reflected via the surface of the reflector. Reflection can be affected by the surface of the reflector or the inclination of the surface. The reflector can be rigidly arranged on the object. Alternatively, the reflector can move about a defined axis, for example in a range of 900 about the z-axis, which is substantially perpendicular to the surface of the ground.

A movement pattern is used may mean a movement that occurs repeatedly at a defined interval of time. In this case, the reflector moves fully or partially about an axis, with this movement taking place in a defined time.

A signal characteristic may be understood as values for the unique assignability of a signal, whereby a reflector can be uniquely identified. Values may include, for example, the intensity or amplitude and/or the distance to the object and/or the temporal profile or frequency. Due to the unique signal characteristic of the reflector, the vehicle can be uniquely identified.

The method allows that vehicles can be detected by the traffic monitoring system even under environmental influences, such as rain.

The movement pattern can be a rotation about the at least one axis. For this purpose, an object can be mounted on an axis driven by an electric motor. Thus, a simple structure and simple control can be used.

In addition, the rotation about the at least one axis can take place at a defined frequency. Thus, each reflector can be assigned a defined frequency, which allows the reflector to be uniquely identified by the traffic monitoring system.

In addition, the defined frequency of the rotation of the reflector can be predefined by the traffic monitoring system. As soon as the reflector has been arranged on the vehicle, the traffic monitoring system can prescribe, for the reflector, a frequency at which the reflector is intended to rotate. This avoids manual double assignments of frequencies or can increase the degree of automation of the traffic monitoring system.

Furthermore, the defined frequency of the rotation of the reflector can be predefined by the vehicle. If, for example, a permanently arranged reflector is located on the vehicle, the vehicle transmits the frequency to the traffic monitoring system. This allows easier compatibility of the traffic monitoring system with the reflector of the vehicle.

The control unit may determine a position of the vehicle by means of the signal characteristic. Through the emission of the signal and the time it takes for the signal to be captured by the receiver, the distance covered can be determined based on the speed constant of the signal. This allows a position to be determined in space.

Furthermore, the reflector may have a defined shape, wherein the shape influences the signal characteristic of the reflector. In one reflector, the surface may be smooth, for example, which means that the signal is reflected back more effectively. In another reflector, the surface is rougher, thus reducing the intensity of the signal by a factor, since the signal is more scattered. However, the reflector can also consist of a different number of elements. For example, it can consist of three elements similar to a triangular prism or four elements similar to a cube. This allows the signal characteristic for a reflector to be uniquely designed.

In one embodiment, two reflectors arranged on the at least one vehicle may be arranged for identifying the at least one vehicle. For example, this can create redundancy, thus improving the safety of the traffic monitoring system.

In addition, the two reflectors can differ in terms of their signal characteristic. If two reflectors are arranged on the vehicle, they can have different movement patterns, which allows a unique assignment to a vehicle. Alternatively, the two reflectors may differ in terms of their shape, which affects the signal characteristic.

In addition, the control unit can generate information about the direction of movement and/or speed and/or length of the vehicle on the basis of the signal characteristics of the two reflectors. This means that additional information, for example for controlling the vehicle, is available to the traffic monitoring system. Each reflector has a unique signal characteristic, in which case the vehicle can be uniquely identified on the basis of these two signal characteristics.

Furthermore, the traffic monitoring system may comprise at least one sensor, wherein the sensor is a camera. This provides the traffic monitoring system with a further type of sensor that differs from the transmitter and receiver. This provides the traffic monitoring system with additional information that improves control of the vehicle and the safety of the traffic monitoring system.

The information generated on the basis of the signal characteristic can be compared with the data from the camera. This allows the determined signal characteristic to be checked for correctness, since reference data can be available to the traffic monitoring system with the data from the camera.

In addition, the at least one reflector can be arranged on the vehicle by means of a mounting device. In this case, the mounting device may include gripping means, whereby the reflector can be arranged for example on a roof rail of the vehicle or on door frames. Thus, the reflector can be retrofitted to the vehicle and the traffic monitoring system can therefore be used for a variety of vehicles.

The at least one reflector can be temporarily arranged on the vehicle by means of the mounting device. The mounting device of the reflector is designed in such a way that the reflector can be mounted, for example, on the vehicle at the transfer station by personnel and can be removed again when leaving the traffic monitoring system. Thus the reflector can be reused and the vehicle itself does not need a permanently mounted reflector.

Furthermore, the mounting device can be a magnet. The magnet can be arranged on a side of the reflector associated with the vehicle roof. For example, the magnet may be arranged in the x-y plane, which essentially corresponds to the plane of the ground, in which case the reflector may be arranged in the z-axis. This allows the reflector to be easily and quickly mounted on the vehicle.

In addition, the at least one reflector may comprise a further distinguishing feature, wherein the further distinguishing feature can be identified by the camera. For example, the distinguishing feature can be a light-emitting means with a defined spectrum, which can be uniquely identified by the camera. The further distinguishing feature can be arranged statically on the at least one rotating reflector. Alternatively, the additional distinguishing feature may be temporarily arranged on the reflector. This allows the traffic monitoring system to obtain a further reference point, for example, for determining distances.

The further distinguishing feature can be arranged behind the reflector, wherein the further distinguishing feature is temporarily concealed by the movement pattern. Temporarily concealing the further distinguishing feature means that the traffic monitoring system can determine the frequency of the movement pattern of the reflector in an additional way and, if necessary, compare it with the frequency of the signal characteristic determined by the receiver.

In addition, the transmitter and the receiver may be in the form of a radar unit. Thus, it simplifies the structure of the traffic monitoring system as well as procurement.

The rotating reflector may be a triple mirror. This allows simple reflection of the signal in the direction of the transmitter and/or receiver in a manner substantially independent of the direction of incidence.

### BRIEF DESCRIPTION OF THE DRAWINGS

Further details will become apparent from the following description in conjunction with the accompanying drawings, in which:

FIG. 1 shows a schematic structure of a traffic monitoring system according to the prior art;

FIG. 2 shows a schematic structure of a traffic monitoring system;

FIG. 3 shows a schematic sequence of the process steps for identifying a vehicle;

FIG. 4 shows a schematic structure according to FIG. 2 with additional sensors;

FIG. 5 shows a plan view of a vehicle with a reflector; and

FIG. 6 shows a side view of a vehicle with two reflectors.

### DETAILED DESCRIPTION

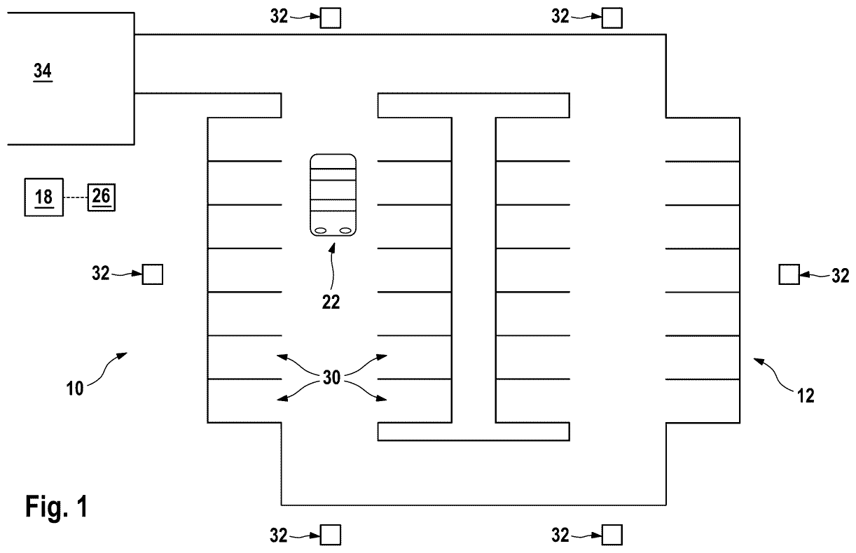

FIG. 1 shows a schematic structure of a traffic monitoring system 10, wherein the traffic monitoring system 10 monitors a traffic area 12. The traffic monitoring system comprises a control unit 12. There is a vehicle 22 in the traffic area 12. An object or reflector 24 is arranged on the vehicle 22.

The vehicle 22 is transferred by the driver or the occupants to the traffic monitoring system 10 in a transfer region not shown. The traffic monitoring system 10 establishes a data connection to the vehicle 22 by means of a communication unit 26. In this exemplary embodiment, the transfer station is located in a parking garage 34 that is not completely shown, but transfer regions outdoors are also conceivable. The traffic monitoring system 10 determines a target position 30, also referred to as a parking space 30 below, by means of the control unit 18. The control unit then determines control commands based on sensor data generated by sensors 32, also referred to as cameras 32 below. The control commands are transmitted to the vehicle 22 by means of the communication unit 26. The control commands are transmitted for example cyclically. The traffic monitoring system 10 then controls the vehicle 22 from a transfer station, not shown, to the parking space 30. For reasons of clarity, not all parking spaces are provided with a reference sign.

Outdoor parking spaces 30 are adjacent to the parking garage 34. The cameras 32, which monitor the traffic area 12 of the outdoor parking spaces 30, are thus exposed to environmental influences, such as rain, snow or fog. The environmental influences have an adverse effect on the generation of sensor data by the cameras 32, as a result of which the traffic monitoring system 10 is temporarily impaired at least in the outdoor traffic area 12. If the sensor data determined by means of the cameras 32 are no longer suitable for determining the control commands by means of the control unit 18, the vehicles 22 must be stopped in the outdoor traffic area 12. This is necessary until the sensor data again allow the control commands to be determined.

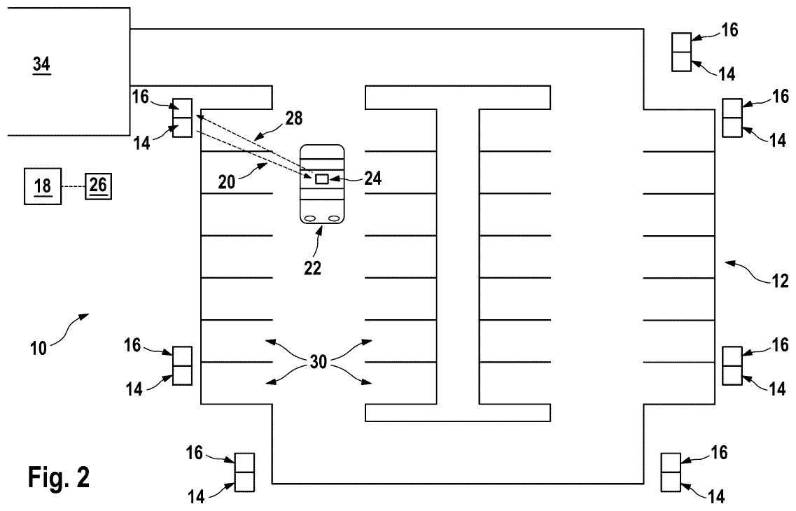

An exemplary embodiment is shown in FIG. 2. A schematic structure of a traffic monitoring system 10 that is approximately identical to FIG. 1 is shown, wherein the traffic monitoring system 10 monitors the traffic area 12. The traffic monitoring system comprises the control unit 12, the transmitter 16 and the receiver 18. There is a vehicle 22 in the traffic area 12. An object or reflector 24 is arranged on the vehicle 22.

The vehicle 22 is transferred by the driver or the occupants to the traffic monitoring system 10 in a transfer region not shown. In this exemplary embodiment, the transfer station is located in the parking garage 34, but transfer regions outdoors are also conceivable. The reflector 24 is attached to the vehicle 22 by personnel or suitable automatic devices, such as a robot. The number of reflectors 24 is not limited for the traffic monitoring system 10.

The traffic monitoring system 10 establishes a data connection to the vehicle 22 by means of the communication unit 26. The data connection may be wireless.

In a first step, the vehicle 22 is registered by the traffic monitoring system. This registration is effected by means of the reflector 24. This has a uniquely defined movement pattern for the reflectors 24 of the traffic monitoring system 10. The movement pattern of the reflector 24 can be predefined by the traffic monitoring system or by the vehicle itself. The transmitter 14 generates a signal 20 which is transmitted in the direction of the reflector. The signal 20 hits the reflector 24, where it is reflected as a reflected signal 28. This reflected signal 28 has a unique signal characteristic. Due to this unique signal characteristic, the traffic monitoring system 10 knows which vehicle 22 is currently at which position in the traffic area. Each signal characteristic is unique to each vehicle.

In addition, registration may comprise transmitting vehicle data, such as license plate number, color, model or brand. The vehicle data are requested by the traffic monitoring system 10 from the vehicle 22 or are transmitted by the vehicle 22 immediately after the data connection to the traffic monitoring system has been established. These data may be stored at least temporarily by the traffic monitoring system, for example until the vehicle 22 leaves the traffic area 12 of the traffic monitoring system 10.

The traffic monitoring system 10 determines a target position 30, also referred to as a parking space 30 below, for the vehicle 22 by means of the control unit 18.

In addition, the control unit uses sensor data to determine control commands for controlling the vehicle 22. The sensor data are generated by the transmitter 14 and the receiver 16 or by sensors not shown, such as ultrasonic sensors or laser sensors arranged above the parking space. The sensor data are determined cyclically, for example in the millisecond range.

The control commands are transmitted to the vehicle 22 by means of the communication unit 26. The control commands are transmitted for example cyclically.

The traffic monitoring system 10 then controls the vehicle 22 from the transfer station, not shown, to the parking space 30. For reasons of clarity, not all parking spaces 30 are provided with a reference sign.

The transmitter 14 and the receiver 16 are arranged, for example, on a lamp not shown or a mast not shown.

Outdoor parking spaces 30 are adjacent to the parking garage 34. If the vehicle 22 is controlled from the parking garage 34 to the outside and the above-mentioned conditions prevail, the vehicle can be controlled further to the parking space 30.

The transmitter 16 also generates, under the environmental influences, the signal 20 which is transmitted in the direction of the reflector 24. The signal 20 is not adversely affected by the environmental influences, for example scattered, or the energy content of the signal is not reduced. The signal is reflected by the reflector 24, wherein the reflected signal 28 has a signal characteristic. As already mentioned, this signal characteristic is unique to each reflector 24 in the traffic area 12 of the traffic monitoring system 10. The reflected signal 28 is captured by the receiver 16. The receiver 16 transmits the captured signal characteristic of the reflected signal 28 to the control unit 18 which uses the signal characteristic for further calculations for controlling the vehicle 22. The reflected signal 28 can be received by a second receiver in order to improve the sensor data.

The signal characteristic comprises information such as the distance between the vehicle 22 and the transmitter 14 and/or the receiver 16, the movement pattern of the reflector 24 and the shape and/or surface of the reflector 24.

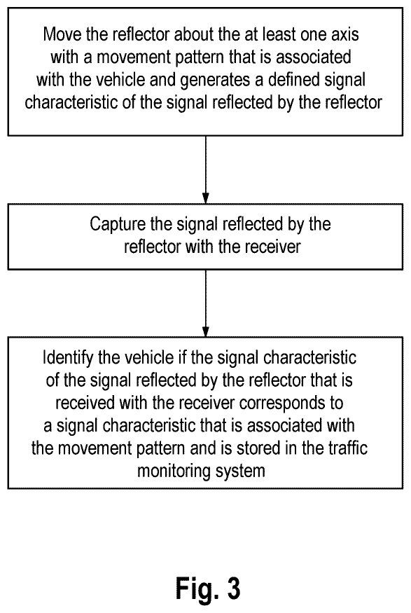

FIG. 3 shows the basic sequence of the method. The following steps are performed: moving the reflector about the at least one axis with a movement pattern that is associated with the vehicle and generates a defined signal characteristic of the signal reflected by the reflector, capturing the signal reflected by the reflector with the receiver, and identifying the vehicle if the signal characteristic of the signal reflected by the reflector that is received by the receiver corresponds to a signal characteristic that is associated with the movement pattern and is stored in the traffic monitoring system.

For example, the steps are performed in succession and, in particular, may be repeated cyclically.

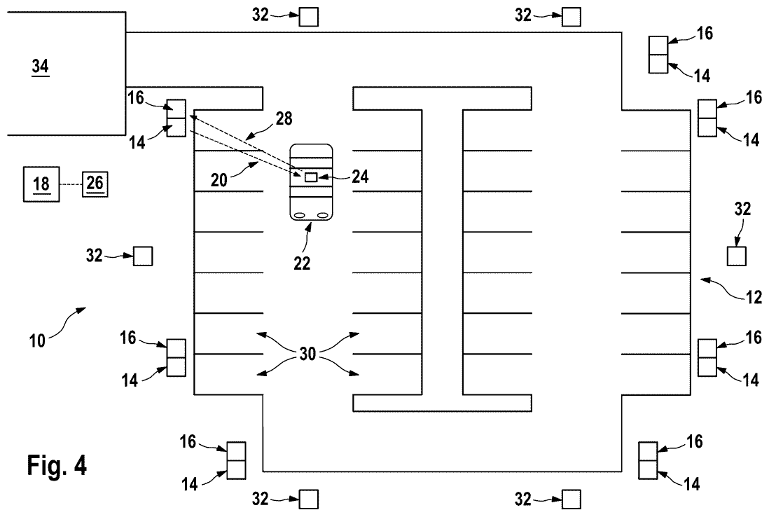

FIG. 4 shows a further exemplary embodiment. This is similar to the example explained under FIG. 2, wherein, in addition to the transmitter 14 and receiver 16, at least one camera 32 is included. The statements made with respect to the previous example also apply to this exemplary embodiment.

The at least one camera 32 in this example generates sensor data which are used by the traffic monitoring system 10 in addition to the signal characteristic of the reflector 24 of the vehicle 22.

The cameras 32 identify the vehicle 22 in the transfer region not shown. In this case, the vehicle data transmitted by the vehicle can be compared with the sensor data generated by the cameras 32.

In addition, a distinguishing feature, not shown, is arranged on the reflector 24 and can be identified by the camera 32. This distinguishing feature is also unique, thus creating a redundant possible way of identifying the vehicle 22.

Alternatively, the distinguishing feature can be arranged behind the reflector 24. Due to the movement of the reflector, the distinguishing feature is only temporarily captured by the camera 32. This allows conclusions to be drawn about the movement pattern, for example at least the frequency, of the reflector.

A light source may be used as a distinguishing feature.

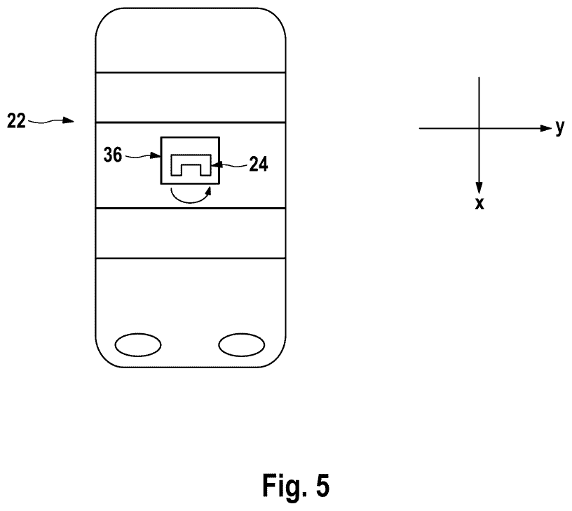

FIG. 5 shows a plan view of the vehicle 22 with a reflector 24. The reflector 24 is arranged on the vehicle 22 by means of the mounting device 36. The reflector 24 has a movement pattern which corresponds for example to a rotation about the z-axis. The rotation about the z-axis is indicated by an arrow. The reflector 24 has for example the shape of a triple mirror. However, other shapes are also possible that reflect the signal 20 generated by the transmitter 14 in the direction of the receiver 16, which is arranged for example in the immediate vicinity of the transmitter 14.

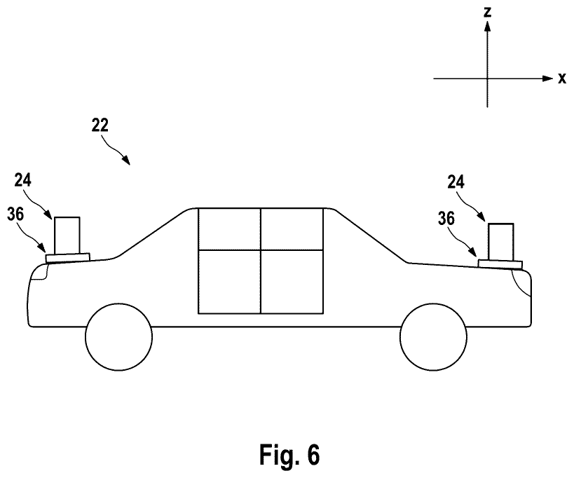

FIG. 6 shows a further exemplary embodiment. This exemplary embodiment differs only in that two reflectors 24 are arranged on the vehicle 22. Each of the reflectors 24 is arranged by means of a mounting device 36. The mounting device 36 is needed in each exemplary embodiment to arrange the reflector 24 on the vehicle 22. The reflectors 24 are oriented substantially parallel to the z-axis, wherein the reflectors 24 in this example rotate about the z-axis. For orientation, an orientation device not shown any further, for example a gravity-based self-aligning bearing, is included in the mounting device 36. The two reflectors 24 have different movement patterns, e.g. different rotational frequencies. One of the two reflectors 24 is arranged in the front region of the vehicle 22, and the other reflector 24 is arranged in the rear region of the vehicle 22. The traffic monitoring system 10 is informed, in particular by the vehicle 22 itself or by personnel, which reflector 24 is arranged at which position on the vehicle 22. This allows the traffic monitoring system 10 to determine the direction in which the vehicle 22 moves, since more than one reflector 24, and thus more than one point, is available for any calculations. Furthermore, the approximate length of the vehicle 22 can be determined by means of the further reflector 24 and the arrangement of the two reflectors 24 in the front and rear region of the vehicle 22, thus making it possible to improve the control of the vehicle 22.

The traffic area 12 is monitored, at least partially, by the cameras 32. In particular, the sensors are positioned in such a way that each region of the traffic area 12 is monitored redundantly.

The transmitter 14, the receiver 16 and the cameras can be connected to the control unit 18 in both a wired and wireless manner.

This applies to all exemplary embodiments.

1. A method for identifying a vehicle in a traffic area with a traffic monitoring system comprising:
transmitting a signal with a transmitter for the traffic monitoring system;
capturing a signal reflected by a reflector arranged on a vehicle moving in the traffic area with a receiver for the traffic monitoring system, wherein the reflector moves about an at least one axis with a movement pattern that is associated with the vehicle such that the reflected signal has a defined signal characteristic; and
identifying, with a control unit, the vehicle when the signal characteristic corresponds to a signal characteristic that is associated with the movement pattern and is stored in the traffic monitoring system.

2. The method as claimed in claim 1, wherein the movement pattern is a rotation about the at least one axis.

3. The method as claimed in claim 1, wherein the rotation about the at least one axis takes place at a defined frequency.

4. The method as claimed in claim 1, wherein the defined frequency of the rotation of the reflector is predefined by the traffic monitoring system.

5. The method as claimed in claim 1, wherein the defined frequency of the rotation of the reflector is predefined by the vehicle.

6. The method as claimed in in claim 1, wherein the control unit can determine a position of the vehicle using the signal characteristic.

7. The method as claimed in in claim 1, wherein the reflector has a defined shape, wherein the shape influences the signal characteristic of the reflector.

8. The method as claimed in in claim 1, wherein two reflectors are arranged on the vehicle for identifying the vehicle.

9. The method as claimed in claim 8, wherein the two reflectors have a different signal characteristic from one another.

10. The method as claimed in claim 8, further comprising generating information with the control unit on the basis of the signal characteristic of the two reflectors, where the information is at least one of: a direction of movement, a speed, and a length of the vehicle.

11. The method as claimed in claim 1, wherein the traffic monitoring system comprises at least one sensor, wherein the sensor is a camera.

12. The method as claimed in claim 11, wherein information generated on the basis of the signal characteristic is compared with data from the camera.

13. The method as claimed in claim 1, wherein the at least one reflector is arranged on the vehicle with a mounting device.

14. The method as claimed in claim 13, wherein the at least one reflector can be removably secured on the vehicle with the mounting device.

15. The method as claimed in claim 14, wherein the mounting device is a magnet.

16. The method as claimed in claim 11, wherein the at least one reflector comprises a further distinguishing feature, wherein the further distinguishing feature can be identified by the camera.

17. The method as claimed in claim 16, wherein the further distinguishing feature is behind the reflector, wherein the further distinguishing feature is temporarily concealed by the movement pattern.

18. The method as claimed in claim 1, wherein the transmitter and the receiver are a radar unit.

19. The method as claimed in claim 1, wherein the reflector is a triple mirror.

20. A traffic monitoring system for monitoring a traffic area comprising:
a transmitter which transmits a signal,
a receiver for capturing a signal reflected by a reflector arranged on a vehicle moving in the traffic area, wherein the reflector moves about an at least one axis with a movement pattern that is associated with the vehicle such that the reflected signal has a defined signal characteristic, and
a control unit with instructions for identifying the vehicle when the signal characteristic of the signal reflected by the reflector that is received by the receiver corresponds to a signal characteristic that is associated with the movement pattern and is stored in the traffic monitoring system.
